(19) United States
(12) Patent Application Publication
(10) Pub. No.: US 2014/0250012 A1
(43) Pub. Date: Sep. 4, 2014

(54) SYSTEM AND METHOD FOR ACQUIRING TRANSACTIONAL DATA ON CONSUMER USE OF GIFT CERTIFICATES AT MERCHANT RETAIL LOCATIONS

(71) Applicant: Giftcards.com LLC, Pittsburgh, PA (US)

(72) Inventor: Jason WOLFE, Sewickley, PA (US)

(73) Assignee: Giftcards.com LLC, Pittsburgh, PA (US)

(21) Appl. No.: 14/196,761

(22) Filed: Mar. 4, 2014

Related U.S. Application Data
(60) Provisional application No. 61/772,180, filed on Mar. 4, 2013.

(51) Int. Cl. G06Q 20/28; G06Q 20/40

(52) U.S. Cl. CPC G06Q 20/28; G06Q 20/40
USPC 705/44

(57) ABSTRACT

Disclosed herein are systems, methods, and computer-readable storage devices for acquiring transactional data on consumer use of discounted gift certificates at merchant retail locations. The system sells a discounted gift certificate in combination with a payment network branded prepaid gift account to a consumer. The consumer can use the prepaid gift account to make a purchase and redeem the gift certificate. The point of sale terminal recognizes that the prepaid gift account has an associated gift certificate value and credits the value of the gift certificate to the purchase. If the purchase amount exceeds the gift certificate, the prepaid gift account processor partially authorizes the amount of the gift certificate and presents the remaining balance of the purchase to the consumer for additional payment. The system can create transaction data describing the amount spent by the consumer in excess of the gift certificate value.

### PRIORITY

This application claims priority to U.S. Provisional Patent Application No. 61/772,180, filed 4 Mar. 2013, the contents of which are herein incorporated by reference in their entirety.

### TECHNICAL FIELD

The present disclosure relates generally to gift certificates, and more specifically to tracking usage of gift certificates.

### BACKGROUND

Today, consumers can purchase online discount gift certificates from online providers such as Groupon® and Living Social®. This business model requires merchant consent and participation as a merchant must accept and honor the discounted gift certificates offered by these online providers. For example, a consumer purchases a gift certificate from an online provider for a restaurant with a $100 face value at a price of $50. The discounted gift certificate allows the consumer to obtain $100 worth of goods and services for the $50 price of the gift certificate. In order for the gift certificate to be valid, the restaurant must agree to accept the gift certificate. Online gift certificate providers typically pay the merchant 50% of the fee charged to the consumer for the gift certificate, in exchange for the merchant's participation in gift certificate program. However, online gift certificate providers often have difficulty in convincing merchants to participate in the gift certificate program for various reasons due to inability to show accurately the merchants return on investment from participating.

A useful tool in convincing a merchant to participate in a gift certificate program would be for the online gift certificate provider to be able to provide data to a merchant indicating that consumers who use gift certificates typically spend more than the face value of the gift certificate generating additional revenue for the merchant. This concept is commonly referred to as “overspend.”

However, online gift certificate providers have no access to transaction data on overspend. Access to such overspend data would be of considerable value an online gift certificate provider because such data could be used as a marketing tool to solicit merchants to participate in the gift certificate programs. For example, if an online gift certificate provider could show that a consumer who purchased a $50 gift certificate for $25 to a restaurant actually spent $90 at the restaurant, such information would constitute valuable marketing information on overspend which could be used by the online gift certificate provider to solicit merchants to participate in their gift certificate program.

### BRIEF DESCRIPTION OF THE DRAWINGS

A description is provided herein with reference to specific examples illustrated in the appended drawings. These drawings depict only example implementations of the disclosure and are not intended to limit the scope of the disclosure.

FIG. 1 illustrates an example system configuration for a gift certificate provider;

FIGS. 2A, 2B, and 2C illustrate views of an example user interface;

FIG. 3 illustrates an example method embodiment; and

FIG. 4 illustrates a computing device system according to an example implementation.

### DETAILED DESCRIPTION

Various examples are provided herein. While specific examples are discussed, it should be understood that this is for illustration purposes only. A person skilled in the relevant art will recognize that other components and configurations may be used without departing from the spirit of the disclosure.

Several definitions that apply throughout this document are now presented. The phrase “coupled” is defined as connected, whether directly or indirectly through intervening components, and is not necessarily limited to physical connections. Coupled devices are devices which are in signal communication with one another.

The term “electronic device” is defined as any device that is capable of at least accepting data, transmitting data, and executing commands. For example, electronic devices may include, but are not limited to, portable communication devices, mobile communication devices, mobile computers, smartphones, computing pads, tablet computers, personal computers, desktop computers, laptop computers, netbooks, servers, routers, set-top phones, or other electronic devices capable of at least accepting data, transmitting data, and executing commands.

The term “gift certificate” can be defined as any physical or virtual instrument which can be presented at a physical or electronic point of sale, which represents some form of stored value for the merchant to which the gift certificate is presented. Some examples include traditional paper gift certificates, plastic prepaid cards such as physical gift cards, coupons, coupon purchase confirmation codes, and so forth.

Disclosed herein is a system and method for acquiring transactional data on consumer use of discounted gift certificates at merchant retail locations. A system and method are disclosed for using a payment network branded, prepaid gift account to track consumer overspend when using discounted gift certificates. The system and method offers for purchase by a consumer a discounted gift certificate in combination with a payment network branded prepaid gift account. The face value of the gift certificate is assigned to the prepaid gift account at the time of the purchase of the gift certificate. Thus, the consumer can use the prepaid gift account to redeem the gift certificate at a merchant by using the prepaid gift account to make a purchase at the merchant associated with the gift certificate. At the time of purchase, the point of sale terminal recognizes that the prepaid gift account has a gift certificate value assigned to the prepaid gift account and credits the value of the gift certificate against the purchase. If the purchase amount exceeds the value of the gift certificate assigned to the prepaid gift account, the prepaid gift account processor partially authorizes a purchase amount in the amount of the gift certificate assigned to the prepaid gift account and then presents the remaining balance of the purchase to the consumer for payment via another payment method such as a credit card, cash or check or another prepaid card. As a result of the partial authorization transaction, transaction data is created and stored by the prepaid gift account processor for the transaction at the merchant including the amount spent by the consumer in excess of the face value of the gift certificate assigned to the prepaid gift account. The transaction data can optionally link the gift certificate and the partial transaction information in a database that identifies individual purchasers, or in a database that aggregates information in an anonymous way. This transaction data can be utilized by online discounted gift certificate providers to solicit merchants to participate in their discounted gift certificate program. Alternatively, the transaction data can be used in analytics to determine which gift certificate face values are likely to encourage overspending for specific merchants or merchant categories, which types of purchasers are likely to overspend, which types of items purchasers are likely to overspend on, or for other analytics or reporting tasks.

Provided herein are some example steps for detecting that a purchaser is spending more than a gift certificate is worth. An example system can be configured to register a gift certificate, such as during the process of loading a prepaid card or creating a coupon. When the Point of Sale processes the gift certificate, the system assigns a value to the gift certificate. When the Point of Sale processes the gift certificate and uses a partial authorization, such as a prepared gift card for $50, and the Point of Sale attempts to charge $80, the system asks the purchaser to pay the remainder not covered by the gift certificate, or $30 more. The system can report at least part of that information on overspending, such as to merchants in response to a promotional campaign, or as a data point to encourage merchants to participate in a gift certificate program.

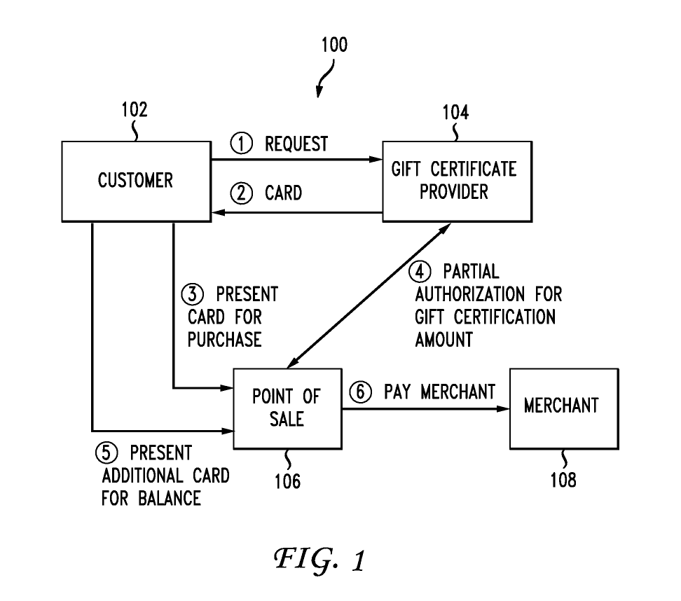

FIG. 1 illustrates an example system configuration 100 for a gift certificate provider 104. At step 1, a customer 102 places a request for a gift certificate to the gift certificate provider 104. At step 2, the gift certificate provider 104 can provide the gift certificate to the customer 102. The gift certificate provider 104 can provide the gift certificate as a card, a paper certificate, a code, or by linking a virtual gift certificate with an existing payment account of the customer 102, for example. Then at step 3, the customer 102 presents the gift certificate to the point of sale 106 for a merchant 108 to pay for a purchase or other transaction. Presenting the gift certificate can include the user presenting or tendering a paper gift certificate, a gift code, a gift identifier, a gift card, or simply paying with an existing payment account that is linked with a virtual gift certificate. At step 4, the point of sale 106 makes a request to the gift certificate provider 104 to authorize payment for the full amount of the transaction from funds available on the gift certificate. The gift certificate provider 104 can authorize the full amount of the transaction if the full amount if smaller than the available balance for the gift certificate. Alternatively, the gift certificate provider 104 can record the requested full amount, and authorize a smaller amount up to or including the available balance for the gift certificate. For example, if the gift certificate has an available balance of $50 and the requested full amount of $35, the gift certificate provider 104 can authorize payment from the available balance for the entire $35. If, however, the requested full amount is $120, then the gift certificate provider 104 can authorize payment of all of the available balance of $50, while noting or recording the requested full amount as an indication of overspend associated with the gift certificate. Thus, the gift certificate provider 104 can provide a partial authorization of the requested full amount.

If the gift certificate provider 104 provides a partial authorization, the customer 102 can, at step 5, tender additional payment for any remaining amount. For example, the customer 102 can pay the additional amount in cash, via a credit or debit card, a check, store credit, another gift card, code, or certificate, electronic currency, services, an exchange, a promissory note, or any other financial or payment instrument that the merchant will accept. Then at step 6, the point of sale 106 can optionally transfer the money from the gift certificate balance and the additional funds tendered by the customer 102, if any, to the merchant 108 or the merchant's account.

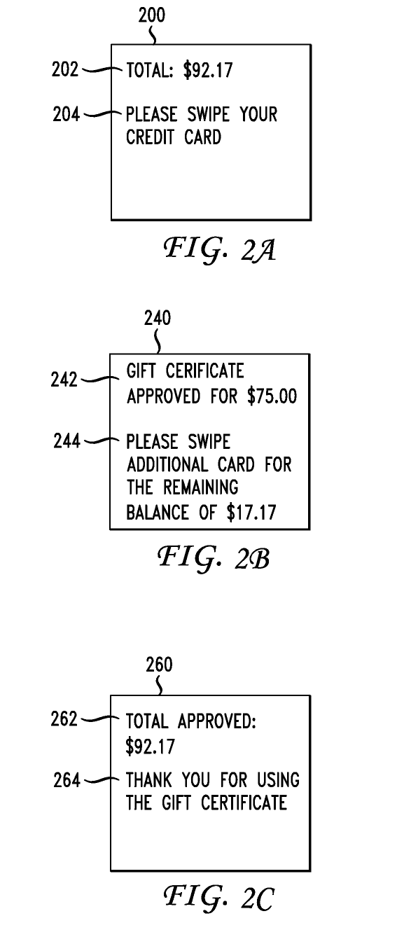

FIGS. 2A, 2B, and 2C illustrate views of an example user interface that could be presented to the customer 102 or to an employee operating the point of sale 106 equipment. FIG. 2A shows a first user interface screen 200. In this screen 200, an employee has scanned each item the customer 102 desired to purchase and arrived at a total of $92.17 including tax 202. The system can present a prompt 204 asking the customer 102 to provide payment. The customer 102 tenders the gift certificate, in whatever form received from the gift certificate provider 104, as payment. In this example, the gift certificate provider 104 approves the gift certificate for a value of $75, so the second user interface screen 240 of FIG. 2B shows a first prompt 242 of that amount, and a second prompt 244 requesting additional payment for the outstanding balance of $17.17. The customer 102 provides additional payment, such as another credit or debit card or cash. FIG. 2C shows a third user interface screen 260 showing the total transaction amount 262, and a message 264 for the customer 102 or the employee operating the point of sale 106. The gift certificate provider can transmit the message to the point of sale 106 as part of the partial authorization in step 4 of FIG. 1, for example.

The gift certificate provider 104 can be a single entity or a collection of entities that each perform separate functionality. For example, a gift certificate issuing entity of the gift certificate provider 104 can issue gift certificates in response to customer 102 requests, and a separate gift certificate authorizing entity can interact with merchant points of sale.

The gift certificate provider 104 can provide notifications to the customer 102, a giver of the gift certificate, the merchant 108, or any other interested party. The notifications can be triggered at any desired point in the lifetime of the gift certificate, such as when the gift certificate is issued, when a gift certificate is tendered at a point of sale, or when the point of sale submits a request to authorize the gift certificate, for example.

In the case of product returns, the merchant point of sale 106 can coordinate with the gift certificate provider 104 to restore all or a part of the funds to the gift certificate account that was used to complete the transaction and maintain or re-establish all or part of the restrictions on the gift certificate. In this way, a customer could not simply make a purchase, immediately return the purchase for cash, and avoid the gift certificate restrictions which may ultimately cost the merchant 108 money.

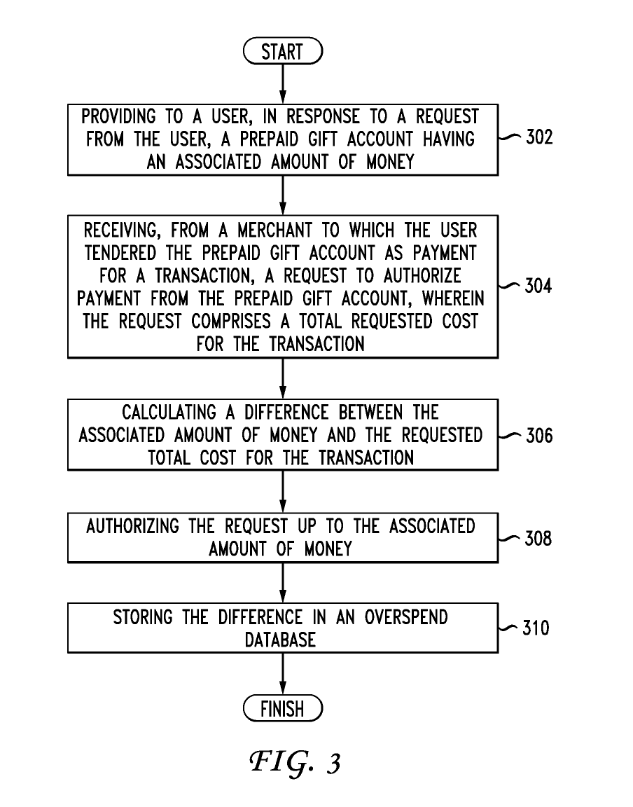

FIG. 3 illustrates an example method embodiment. The example system can provide to a user, in response to a request from the user, a prepaid gift account having an associated amount of money (302). The prepaid gift account can embodied as a gift card, a prepaid debit account, a gift certificate, a merchant category restricted payment account, or any other suitable payment, gift, discount, or financial instrument, including virtual or purely electronic instruments. The system can receive, from a merchant to which the user tendered the prepaid gift account as payment for a transaction, a request to authorize payment from the prepaid gift account, wherein the request includes a total requested cost for the transaction (304).

The system can calculate a difference between the associated amount of money and the requested total cost for the transaction (306), then the system can authorize the request up to the associated amount of money (308). Authorizing the request can include transferring at least a portion of the associated amount of money to the merchant. If the requested total cost for the transaction is greater than the associated amount of money, the system can authorize the request for all of the associated amount of money. If the requested total cost for the transaction is less than the associated amount of money, the system can authorize a portion of the associated amount of money. In some cases, the user makes multiple transactions for the same gift certificate, such as multiple smaller transactions which do not exhaust the available balance of the gift certificate. Thus, the system can track a set of requests to authorize payment, and when a combined requested total cost of the set of requests is greater than the associated amount of money, the system can calculate an aggregate difference between the combined requested total cost and associated amount of money and store the aggregate difference in the overspend database.

The system can store the difference in an overspend database (310). The overspend database can optionally link transaction data to the request or to the user or not, or can link the transaction data in a user-identifiable way, or can link the transaction data in an anonymous way. The overspend database can combine all requests to authorize payment associated with a same prepaid gift account into a single database entry.

The system can optionally generate an overspend report based on differences stored in the overspend database. Such an overspend report can describe which gift amounts are likely to encourage overspending, which gift amounts are likely to encourage overspending for a specific merchant, which gift amounts are likely to encourage overspending for a merchant category, which types of purchasers are likely to overspend, or on which types of items purchasers are likely to overspend, for example. The reports can include customer data or can be completely anonymous. The reports can be presented as part of promotional material to demonstrate to a merchant how much overspend to expect, on average, from customers with gift certificates. In this way, a gift certificate provider can promote the use of gift certificates with actual statistical data and extrapolate to predict the effect gift certificates would have for a target merchant.

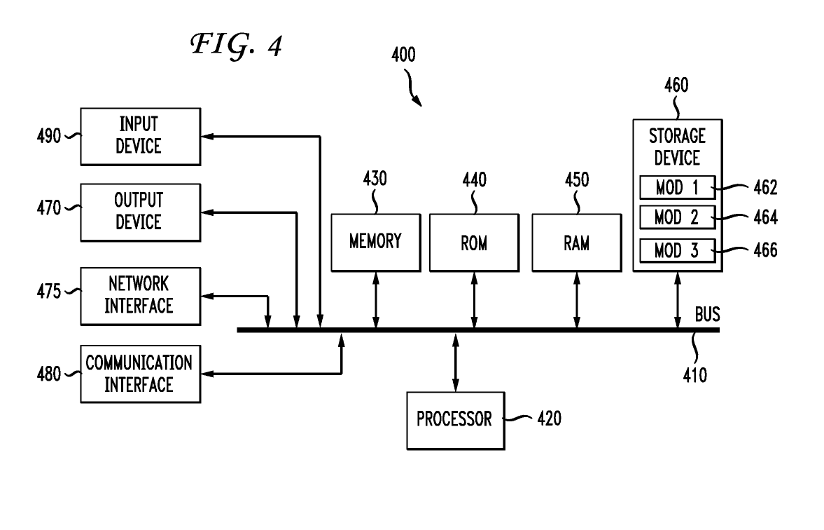

The disclosure now turns to a brief description of a basic general purpose system or computing device, as shown in FIG. 4, which may be employed to practice the concepts disclosed herein. The components disclosed herein may be incorporated in whole or in part into handsets, transmitters, servers, and/or any other electronic or other computing device.

With reference to FIG. 4, an example system 400 includes a general-purpose computing device 400 or electronic device; including a processing unit (CPU or processor) 420 and a system bus 410 that couples various system components to the processor 420. The system components include a system memory 430 such as read only memory (ROM) 440 and random access memory (RAM) 450. The system 400 may include a cache 422 of high speed memory connected directly with, in close proximity to, or integrated as part of the processor 420. The system 400 copies data from the memory 430 and/or the storage device 460 to the cache 422 for quick access by the processor 420. In this way, the cache provides a performance boost that avoids processor 420 delays while waiting for data. These and other modules may control or be configured to control the processor 420 to perform various actions. Other system memory 430 may be available for use as well. The memory 430 may include multiple different types of memory with different performance characteristics. It may be appreciated that the disclosure may operate on a computing device 400 with more than one processor 420 or on a group or cluster of computing devices networked together to provide greater processing capability. The processor 420 may include any general purpose processor and a hardware module or software module, such as module 1 462, module 2 464, and module 3 466 stored in storage device 460 configured to control the processor 420 as well as a special-purpose processor where software instructions are incorporated into the actual processor design. The processor 420 may be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output system (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 may include software modules 462, 464, 466 for controlling the processor 420. Other hardware or software modules are contemplated. The storage device 460 is connected to the system bus 410 by a drive interface. The drives and the associated computer readable storage media provide nonvolatile storage of computer readable instructions, data structures, program modules, and other data for the computing device 400. In one aspect, a hardware module that performs a particular function includes the software component stored in a non-transitory computer-readable medium in connection with the necessary hardware components, such as the processor 420, bus 410, display 470, and so forth, to carry out the function. The basic components are known to those of skill in the art and appropriate variations are contemplated depending on the type of device, such as whether the device 400 is a small, handheld computing device, a desktop computer, or a computer server.

Although the example described herein employs the hard disk 460, it should be appreciated by those skilled in the art that other types of computer readable media which may store data that are accessible by a computer, such as magnetic cassettes, flash memory cards, digital versatile disks, cartridges, random access memories (RAMs) 450, read only memory (ROM) 440, a cable or wireless signal containing a bit stream and the like, may also be used in the example operating environment. Non-transitory computer-readable storage media expressly exclude media such as energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 may also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

For clarity of explanation, the illustrative system example is presented as including individual functional blocks including functional blocks labeled as a “processor” or processor 420. The functions these blocks represent may be provided through the use of either shared or dedicated hardware, including, but not limited to, hardware capable of executing software and hardware, such as a processor 420, that is purpose-built to operate as an equivalent to software executing on a general purpose processor. For example the functions of one or more processors presented in FIG. 4 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 440 for storing software performing the operations discussed below, and random access memory (RAM) 450 for storing results. Very large scale integration (VLSI) hardware examples, as well as custom VLSI circuitry in combination with a general purpose DSP circuit, may also be provided.

The logical operations of the various examples are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400 shown in FIG. 4 may practice all or part of the recited methods, may be a part of the recited systems, and/or may operate according to instructions in the recited non-transitory computer-readable storage media. Such logical operations may be implemented as modules configured to control the processor 420 to perform particular functions according to the programming of the module. For example, FIG. 4 illustrates three modules Mod 4 462, Mod 2 464 and Mod 3 466 which are modules configured to control the processor 420. These modules may be stored on the storage device 460 and loaded into RAM 450 or memory 430 at runtime or may be stored as would be known in the art in other computer-readable memory locations.

Examples within the scope of the present disclosure may also include tangible and/or non-transitory computer-readable storage media for carrying or having computer-executable instructions or data structures stored thereon. Such non-transitory computer-readable storage media may be any available media that may be accessed by a general purpose or special purpose computer, including the functional design of any special purpose processor as discussed above. By way of example, and not limitation, such non-transitory computer-readable media may include RAM, ROM, EEPROM, CD-ROM, or other optical disk storage, magnetic disk storage or other magnetic storage devices, or any other medium which may be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply not only to a smartphone device but also to other devices capable of hands-free input such as a laptop computer. Those skilled in the art will readily recognize various modifications and changes that may be made to the principles described herein without following the example implementations and applications illustrated and described herein, and without departing from the scope of the disclosure.

We claim:

1. A method comprising:
providing to a user, in response to a request from the user, a prepaid gift account having an associated amount of money;
receiving, from a merchant to which the user tendered the prepaid gift account as payment for a transaction, a request to authorize payment from the prepaid gift account, wherein the request comprises a total requested cost for the transaction;
calculating a difference between the associated amount of money and the requested total cost for the transaction;
authorizing the request up to the associated amount of money; and
storing the difference in an overspend database.

2. The method of claim 1, wherein the requested total cost for the transaction is greater than the associated amount of money, the method further comprising:
authorizing the request for all of the associated amount of money.

3. The method of claim 1, wherein the requested total cost for the transaction is less than the associated amount of money, the method further comprising:
authorizing a portion of the associated amount of money.

4. The method of claim 3, further comprising:
tracking a plurality of requests to authorize payment;
when a combined requested total cost of the plurality of requests is greater than the associated amount of money, calculating an aggregate difference between the combined requested total cost and associated amount of money; and
storing the aggregate difference in the overspend database.

5. The method of claim 1, further comprising:
generating an overspend report based on differences stored in the overspend database.

6. The method of claim 5, wherein the overspend report describes at least one of which gift amounts are likely to encourage overspending, which gift amounts are likely to encourage overspending for a specific merchant, which gift amounts are likely to encourage overspending for a merchant category, which types of purchasers are likely to overspend, and on which types of items purchasers are likely to overspend.

7. The method of claim 1, wherein authorizing the request comprises transferring at least a portion of the associated amount of money to the merchant.

8. The method of claim 1, wherein the overspend database does not link transaction data to the request or to the user.

9. The method of claim 1, wherein the overspend database links transaction data to at least one of the request and the user.

10. The method of claim 1, wherein the overspend database combines into a single entry all requests to authorize payment associated with a same prepaid gift account.

11. The method of claim 1, wherein the prepaid gift account comprises at least one of a gift card, a prepaid debit account, a gift certificate, and a merchant category restricted payment account.

12. A system comprising:
a processor; and
a computer-readable storage device having stored therein instructions which, when executed by the processor, cause the processor to perform operations comprising:
registering a gift certificate with a user, wherein the gift certificate is assigned a gift value;
receiving an indication that the user has tendered the gift certificate at a point of sale of a merchant to pay for a transaction amount;
upon verifying that the gift certificate is valid, authorizing payment up to the gift value to the merchant; and
recording a difference of how much larger the transaction amount is over the gift value.

13. The system of claim 12, the instructions, when executed by the processor, causing the processor to perform operations further comprising:
tracking a plurality of payment authorizations for the gift certificate and associated transaction amounts;
when a combined total of the associated transaction amounts is greater than the gift value, calculating an aggregate difference between the combined total and gift value; and
recording the aggregate difference.

14. The system of claim 12, the instructions, when executed by the processor, causing the processor to perform operations further comprising:
generating an overspend report based on the difference.

15. The system of claim 14, wherein the overspend report describes at least one of which gift amounts are likely to encourage overspending, which gift amounts are likely to encourage overspending for a specific merchant, which gift amounts are likely to encourage overspending for a merchant category, which types of purchasers are likely to overspend, and on which types of items purchasers are likely to overspend.

16. The system of claim 12, wherein authorizing payment up to the gift value to the merchant further comprises transferring at least a portion of the gift value to the merchant.

17. A non-transitory computer-readable storage device having stored therein instructions which, when executed by a computing device, cause the computing device to perform operations comprising:
providing to a user, in response to a request from the user, a prepaid gift account having an associated amount of money;
receiving, from a merchant to which the user tendered the prepaid gift account as payment for a transaction, a request to authorize payment from the prepaid gift account, wherein the request comprises a total requested cost for the transaction;
calculating a difference between the associated amount of money and the requested total cost for the transaction;
authorizing the request up to the associated amount of money; and
storing the difference in an overspend database.

18. The non-transitory computer-readable storage device of claim 17, wherein the overspend database links transaction data to at least one of the request and the user.

19. The non-transitory computer-readable storage device of claim 17, wherein the overspend database combines into a single entry all requests to authorize payment associated with a same prepaid gift account.

20. The non-transitory computer-readable storage device of claim 17, wherein the prepaid gift account comprises at least one of a gift card, a prepaid debit account, a gift certificate, and a merchant category restricted payment account.
